(19) United States
(12) Patent Application Publication
(10) Pub. No.: US 2003/0183021 A1
(43) Pub. Date: Oct. 2, 2003

(54) Method for measurement of the fracture toughness of a coating or a surface

(76) Inventor: Kenneth Holmberg, Espoo (FI)

Correspondence Address: YOUNG & THOMPSON, 745 SOUTH 23RD STREET 2ND FLOOR, ARLINGTON, VA, 22202

(21) Appl. No.: 10/362,605

(22) PCT Filed: Aug. 28, 2001
(86) PCT No.: PCT/FI01/00752

(30) Foreign Application Priority Data
Aug. 31, 2000 (FI) 20001919

(51) Int. Cl. G01M 19/00

(52) U.S. Cl. 73/865.3

(57) ABSTRACT

The invention relates to a method for the measurement of the fracture toughness of a coating or surface, in which method a hard stylus is drawn with an increasing normal force along the surface of an object so that the surface undergoes damage by fracture. Using an optical, acoustical or other technical method, the location of the first cracks on or near the scratch groove is measured, the frictional forces at the crack positions are measured, and, using these data, the fracture toughness of the coating or surface is calculated via a fracture mechanical analysis. The scratching of the surface using a hard stylus with a force increasing in a controlled manner can be implemented via a so-called scratch test known in prior art, by providing it with acoustic emission or equivalent detector measuring the location of appearance of the first crack, provided that it includes a force detector for continuous measurement of frictional force.

The present invention relates to a method for measuring the fracture toughness of a coating or surface, in which method a hard stylus is drawn with an increasing normal force along the surface of an object, causing fracture damage of the surface. The position of the first cracks appearing along or near the scratch groove is measured optically, acoustically or by some other technical method, the frictional forces in the crack positions are measured and, using these data, the fracture toughness of the coating or surface is computed via a fracture mechanical analysis.

The wear resistance of a surface and its adaptation during use depend on its material properties. A knowledge of these is the starting point for a successful choice of materials to be used in the components of different types of conveying equipment, machines, appliances, utility articles and corresponding products and in tools and for ensuring their reliability and useful life.

A material may undergo mechanical adaptation and damage with elastic reversible deformation, permanent plastic deformation and fracture. Elastic and plastic deformations of a coating and surface are known and their basic mechanisms are described in textbooks. Parameters describing elastic and plastic deformations are Young's modulus of elasticity, Poisson's ratio and hardness (e.g. Vickers, Rockwell etc.). These can be measured in a known manner from a coating or surface e.g. by means of a hardness tester or a micro-hardness tester.

However, hard coatings, such as e.g. titanium nitride and titanium carbide coatings, hard carbon coatings (diamond and diamond-like carbon coatings), aluminium oxide coatings etc. and their combinations, which are rapidly gaining ground at present, very often undergo damage by fracture. Such coatings are often very thin, down to a thickness as small as only one micrometer. They are produced by many different manufacturing methods, including the fairly well known PVD (Physical Vapour Deposition) and CVD (Chemical Vapour Deposition) methods based on a vacuum technique. Coatings formed by these methods typically have a thickness in the range of 0.1-20 μm.

The fracture resistance of a material is generally described in terms of its critical fracture toughness. However, there is no satisfactory method for the measurement of the fracture toughness of a thin coating or surface. The methods so far disclosed have considerable shortcomings.

Previously known is a so-called indenter or penetration method, whereby the formation of a fracture in a surface is observed and measured by pressing a hard stylus against the surface until the surface is fractured (Diao,D. F., Kato,K. and Hokkirigawa,K., Fracture Mechanisms of Ceramic Coatings in Indentation, Trans. ASME/Journal of Tribology, 116(1994)860-869 and Nastasi, M., Kodali,P., Walter,K. C., Embury,J. D., Raj,R. and Nakamura,Y., Fracture Toughness of Diamondlike Carbon Coatings, Journal of Materials Research, 14(1999)2173-2180). The form of the cracks can be studied in this way, but measuring the fracture toughness by this method is difficult because the point of stress at which the first fractures appear can not be accurately detected as they are covered by the stylus at that instant.

Another known method of measuring the cracking resistance of a coating is to use a so-called bending test (Wiklund,U., Bromark,M., Larsson,M., Hedenquist,P., and Hogmark,S., Cracking resistance of thin hard coatings estimated by four-point bending, Surface and Coatings Technology, 91(1997)57-63). In this method, a thin test piece prepared for this purpose is coated and the piece is then bent symmetrically from both sides by means of two pressing heads placed at different distances. In this way, a controlled tensile stress acting on the surface can be created by increasing the load and the formation of the first cracks can be observed. However, this method has the drawback that it requires the acquisition of a specific bending apparatus and the preparation of a test piece for this purpose. In addition, the test is carried out in a sweep electron microscope (SEM), which is a remarkably expensive apparatus and has to be operated by a specialist having a long experience in the use of the apparatus. As the shape of the test piece is different from the shape of a coated body or tool actually used, this has an effect on the material properties of the surface when coated and therefore the measured cracking resistance of the test piece does not always accurately represent the cracking resistance of an actual object surface.

The object of the invention is to eliminate the above-mentioned disadvantages.

By the method of the invention, the scratching of a surface by means of a hard stylus with controlled increase of force can be performed using a previously known device, i.e. via a so-called scratch test, by providing it with an acoustic emission or equivalent detector for measuring the location of appearance of the first crack, and provided that it includes a force detector for continuous measurement of frictional force. This function is described in European standard prEN1071-3/1999, and the scratch test device is the commonest device used for the measurement of the quality and properties of thin hard coatings. Thus, generally those who have a need to measure the fracture toughness of a coating or surface often already have this basic piece of equipment at their disposal. The scratch test can be performed directly on an actual component or tool, so it is not necessary to prepare a separate test piece for this purpose. As the scratch is so thin and short, generally about 10 mm, it can generally be made beside the working surface so that it will not hinder future operation of the component or tool.

As the stylus used in the scratch test moves with an increasing force through a distance of about 10 mm, the result is a surface that can be visually examined to discover the cracks produced by different loads and thus the first cracks produced can be located. The scratch test device has to be provided with a sensor for the measurement of the frictional force as the stylus is moving along the contact groove.

At present, a scratch test device is only used for measuring the adhesion of a coating and for qualitative determination of the form of damage. The use of a scratch test for this purpose is also recommended by the European standard prEN1071-3/1999. Adhesion measurement by scratch test has been criticised in public literature because adhesion cannot be described in terms of an exact physical parameter. Most commonly and also in the aforesaid standard, it is described in terms of lower and higher critical loads, the physical definition of which is vague and therefore it is almost inapplicable for many purposes, such as modelling and optimisation of surface properties.

In public literature, no one has suggested that the scratch test could also be used for measuring the fracture toughness of a coating or surface as in the method of the present invention, and to our knowledge, it has never been used for that purpose before. To allow the scratch test to be used for the purpose described in the invention, it is necessary to include in the test a force detector for continuous measurement of frictional force and an acoustic emission detector or equivalent for measuring the location of appearance of the first crack.

The invention is characterised in that the first cracks produced in a scratch test are measured optically, acoustically or by some other technical method to determine their location on or near the scratch groove, the frictional forces at the crack positions are measured and, using these data, the fracture toughness of the coating or surface is calculated via a fracture mechanical analysis.

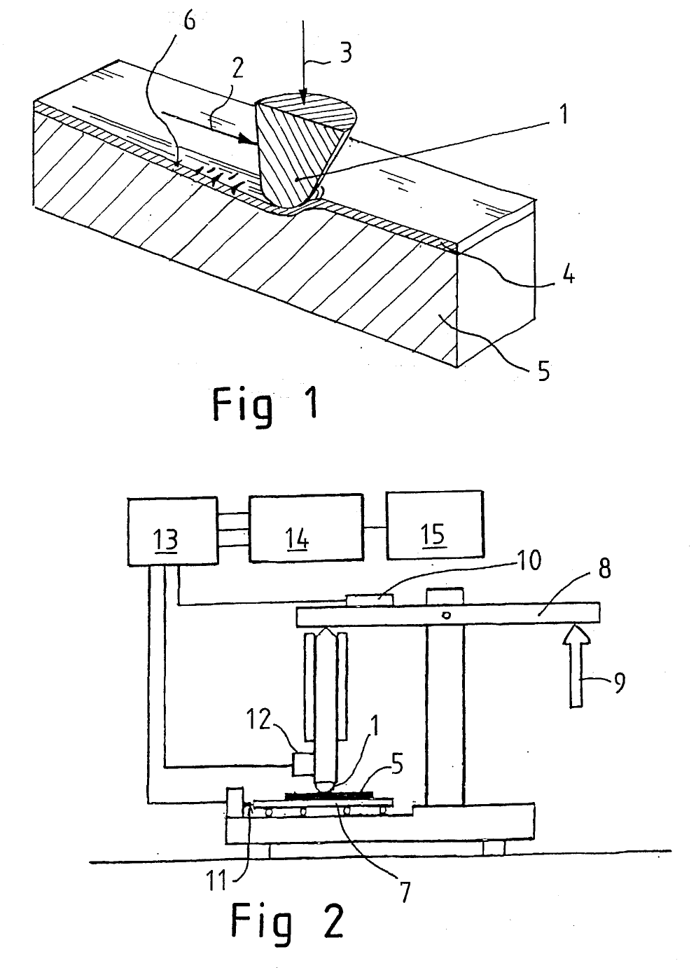

FIG. 1 is an axonometric drawing showing a hard stylus making a groove and cracks on a coated level surface,

FIG. 2 represents a crack test device.

In the method of the invention, a hard stylus (1) is drawn as shown in FIG. 1 with a normal force (3) increasing in the direction of motion (2) across an object (5) coated with a coating (4) so that the surface is damaged and cracks (6) appear in it.

By way of example, the drawing in FIG. 2 illustrates the structure of a previously known scratch test device which can be used to implement the measuring method of the invention. A test piece table (7) moves a coated object (5) under a hard stylus (1) producing a scratch. Via a moment arm (8), a power source (9) applies an increasing load force to the stylus (1), which load force is measured continuously by a force detector (10). The frictional force is measured continuously by a force detector (11), and the location of the first cracks can be detected by means of an acoustic emission detector (12). The measured data are transmitted via a control unit (13) to a data collecting device (14) and further to a computer (15). Based on the measured location data for the first cracks and the corresponding frictional force data, the fracture toughness of the coating can be calculated by means of the computer (15) using fracture mechanical calculation methods, the geometrical form of the stylus and other normal material data concerning the stylus, coating and the object being known. The required material data typically includes the modulus of elasticity, Poisson's ratio, hardness and surface roughness values, which can be measured by generally known methods described in relevant textbooks.

For the detection of the first cracks, various techniques can be used. They can be detected on the surface of a test piece by means of an optical or other type of microscope, they can be measured on the basis of an acoustic emission signal or by some other technical crack detection method.

When examining an object coated with a very thin coating, such as e.g. a coating produced by the aforementioned PVD or CVD techniques and having a thickness of about one micrometer, a fracture toughness value for the coating can be measured directly by the method of the invention. In the same way, an uncoated object can be examined by this method, and in this case a fracture toughness value for the surface, i.e. for the outermost layer of the object is obtained.

1. Method for the measurement of the fracture toughness of a coating or surface, in which method a hard stylus is drawn with an increasing normal force along the surface of an object so that the surface undergoes damage by fracture, characterised in that, using an optical, acoustical or other technical method, the location of the first cracks produced on or near the scratch groove is measured, and the frictional forces at the crack positions are measured, and, using these data, the fracture toughness of the coating or surface is calculated via a fracture mechanical analysis.
